(19) United States
(12) Patent Application Publication
(10) Pub. No.: US 2024/0140733 A1
(43) Pub. Date: May 2, 2024

(54) PICK FLAT PLACE CURVED ASSEMBLY TOOL, SYSTEM AND METHOD

(71) Applicant: APTERA MOTORS CORP., San Diego, CA (US)

(72) Inventors: Aiden CROWE, Durham, NC (US); Anuj THAKKAR, Encinitas, CA (US)

(73) Assignee: APTERA MOTORS CORP., San Diego, CA (US)

(21) Appl. No.: 18/499,696

(22) Filed: Nov. 1, 2023

Related U.S. Application Data
(60) Provisional application No. 63/381,866, filed on Nov. 1, 2022.

(51) Int. Cl. B65G 47/91

(52) U.S. Cl. CPC B65G 47/91

(57) ABSTRACT

A pick-and-place assembly tool, system and method comprising a flexible array of gripper heads is adapted to pick a sheet of flexible material or a pre-assembled array of flexibly coupled elements from a flat surface and place it on a convex, doubly curved surface. Gripping action may be provided by a suction force. When picking the pre-assembled array of elements, the array of gripper heads may conform to the flat surface. The assembly tool may then be moved above and aligned to the compound curved placing surface. When lowered onto the receiving surface, the assembly tool passively may precisely conform to the convex surface. Distortion of the material or array may be controlled by flexible couplers disposed between the gripper heads. Heating elements disposed on some or all of the gripper heads may be used to tack the workpiece in place to maintain registration during subsequent processing, e.g., lamination.

### CROSS REFERENCE TO RELATED APPLICATION

This application is a conversion of, and claims the benefit of, co-pending U.S. Provisional Patent Application No. 63/381,866, entitled “Pick Flat Place Curved Assembly Tool, System and Method”, filed on Nov. 1, 2022, which is incorporated herein by reference in its entirety.

### TECHNICAL FIELD

The present disclosure relates generally to an apparatus, system, and method for arranging a flexible sheet or array of elements on a complex curved surface and specifically to the picking of a flat, flexible array of solar cells and placing on a doubly curved solar panel substrate.

### BACKGROUND

The materials or components for manufacturing assemblies with complex curved surfaces are often flat and have some degree of flexibility. These components are required to conform to the curved surface in the assembly process. For doubly curved surfaces this can require a distortion of the material or component, such as expansion, contraction, bending, twisting, rotating, folding or shearing.

In the aircraft industry, for example, fabrication of carbon fiber composites for wings, fuselages, and other aircraft panels begins with a mold and sheets of carbon fiber material. Pre-cut sheets are arranged in the mold with precise positioning and flexing to achieve the required conformity. This is a challenging operation to automate since some areas of the sheet must be fixed while others can flex and/or slip. Conventional automation may employ an array of gripper heads which flexes between a flat configuration and the shape of a concave mold by combining mechanical actuation and gravity to create a smooth, doubly curved tool surface that matches the shape of the mold. However, problems occur when using this approach to move from a flat configuration to a convex surface because mechanical actuation (convex-inducing) and gravity (concave-inducing) oppose each other leading to deviations from the intended curvature. Another disadvantage is that active mechanical actuation may be more expensive to implement than a passive conformal alignment system.

In the solar panel market demand has emerged for flexible and/or curved solar panel(s) for use in various applications, for example buildings, vehicles, aircraft, and spacecraft. Damage and/or fracture of the delicate solar cells are problems that persist in current manufacturing processes of solar panels with complex geometries. Specifically, solar cell failure may be attributed to the stress caused by simple or complex bending, torsion, or other deformation within the solar cell during handling of the bare cell, strings of cells, or arrays of cells. Therefore, an important aspect of curved solar panel fabrication is the handling and arranging of solar cells to match complex panel shapes in any format such as single cells, strings of cells, or arrays of cells. Picking and placing of large, flexible arrays of elements when moving from a flat surface to a curved surface requires both a three-dimensional spatial transformation and precision alignment. It is particularly difficult to maintain the precision and alignment of the placed solar cells during subsequent operations, such as busbar soldering and/or lamination. Consequently, there is a long-felt need for an assembly tool and manufacturing process that provides damage-free handling, precision placement and holding registration of bare cells, strings of cells, or arrays of cells from a flat surface to a convex surface in the manufacturing of mobile and/or curved solar panels.

Conventionally, solar cells are partially assembled in a flat state wherein the cells and interconnects may be supported throughout the soldering operation. The assembly of cells into linear strings, i.e., rows, for example, is often automated as in the case of flat solar panel manufacturing. A string is composed of the solar cells and the intra-row interconnects, which form bendable mechanical connections as well as electrical connections between the cells. The strings are then either manually or robotically arranged into arrays on a flat substrate. Rows are connected via inter-row busbars, which are soldered in place on the substrate, often manually. Adapting this approach to curved surfaces, strings may be moved from a flat, partially assembled state to a curved, concave substrate and arranged to fill the surface, thereby forming an array, whereupon the rows are connected to each other with busbars. Note that, for a solar panel with a convex solar-facing surface, the assembly must occur in a concave mold to provide access to the back electrodes of the solar cells. The intra-row (string) interconnects typically allow for only a small amount of expansion or contraction between cells, if any. Therefore, the curvature of the substrate must be accommodated by the expansion or contraction of the space between the rows. This results in a slightly non-uniform array of cells whereby the spacing between rows is greater near the center of the array and smaller at the ends of the rows. Additionally, care must be taken to avoid overlapping cells at the ends of the rows or cracking of the cells may result.

Alternatively, cells may be pre-assembled into a complete array in a flat state. This approach has the advantage of avoiding busbar soldering on a curved surface where it is difficult to support the cells and busbars completely, which may subject the cells to cracking and/or the busbars to incomplete soldering. Moreover, problems of solar cell failure may occur due to the stress caused by simple or complex bending, torsion, or other deformation during the grabbing and transfer of an entire flexible cell array from a flat to a curved surface. For example, if the cells are connected in a serpentine manner, then each row must be supported individually throughout the transfer. Alternatively, temporary tethers may be disposed between the ends of the rows that are not soldered together. These approaches are complex and do little to reduce the risk of damage to the delicate solar cell array. Consequently, there is a long-felt need for an assembly tool and manufacturing process that provides for the picking and placing of a fully assembled array of solar cells from a flat surface to a convex surface where the assembled cells and interconnects are supported throughout the operation.

Some apparatuses and methods have been proposed to address these issues. In a first approach, a cell sub-assembly, such as a string or sub-array, or a full array is pre-laminated between sheets of encapsulant, with attention being paid to avoid full curing of the encapsulant such that it may be fully cured in a subsequent lamination step. The pre-lamination is performed with the cells and interconnects in a flat state. The resulting pre-laminate both protects the delicate cells and renders them easier to handle. The string, sub-array, or full array is then arranged and aligned on the curved surface of the substrate. In the case of the strings or sub-arrays, final interconnection via busbars must take place in-situ on the curved, and once again convex, surface. If a full array is used, the latter step may be avoided. However, for the case of full arrays, problems arise when the flat, two-dimensional pre-laminate is placed on the complex curved surface because an excess or dearth of encapsulant between the rows at the distortion points of the regular grid may result. One proposed solution is to add slits between the rows to accommodate expansion. How well this works is an open question. Consequently, there is a long-felt need for an assembly tool and manufacturing process that solves the problem of excess or lack of encapsulant between the rows at the distortion points of the regular grid.

In a second approach, a sub- or full array is assembled in a flat state including end-of-row busbars.

Temporary connections are then made between adjacent busbars, such as, for example, with adhesive tape, forming a border along two opposing sides, with the intra-row connectors forming a border along the intervening two sides. This complete border allows the sub- or full array to be handled by the corners. When this arrangement is transferred to the curved substrate, variable expansion between the rows accommodates the distortion of the array necessary to conform to the curved surface. The temporary border must be removed in-situ and the rows re-aligned to allow the necessary variable expansion or contraction, a complex, manual process that does little to reduce the risk of damage to the delicate solar cell array. Consequently, there is a need for a manufacturing process that avoids additional manufacturing process steps that increase cost, time, and/or solar cell failure due to the stress caused by bending, torsion, or other deformation during handling and transfer of an entire, flexible cell array from a flat to a curved surface.

Conventionally, some or all of these processes (placement, alignment, soldering, etc.) are performed manually and are labor intensive. As a result, complex geometry solar panel manufacturing can be difficult to do in a high-volume, high yield manner.

What is needed is a pick flat, place curved (PFPC) assembly tool, system and method that overcomes the aforementioned problems, and that is also suitable for automated manufacturing and capable of reliably and precisely picking a flexible array of elements and placing it on a curved surface with the required conformity, registration, and retention.

### SUMMARY

It is an object of the present disclosure to provide an apparatus, system and method for picking and placing of flexible sheets or arrays of elements from a flat surface to a convex curved surface requiring a spatial transformation and precision alignment.

It is an object of the present disclosure to provide an apparatus, system and method for picking a flexible array of solar cells assembled on a flat surface and placing it on a doubly curved solar panel.

It is an object of the present disclosure to provide an apparatus, system and method for maintaining the position of a solar cell array on a doubly curved solar panel for subsequent processing.

It is an object of the present disclosure to provide a doubly curved solar panel that is compatible with vehicular applications.

It is an object of the present disclosure to provide a doubly curved solar panel that may be mass produced at low cost.

Other desirable features and characteristics will become apparent from the subsequent detailed description, the drawings, and the appended claims, when considered in view of this summary.

### DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 illustrates a perspective view of a pick flat, place curved assembly tool, according to an embodiment of the present invention;

FIG. 2 illustrates a perspective view of a suction-only gripper head, according to an embodiment of the present invention;

FIG. 3 illustrates a front, right, top perspective view of a heat-enabled, gripper head, according to an embodiment of the present invention;

FIG. 4 illustrates a front, right, bottom perspective view of a heat-enabled, gripper head, according to an embodiment of the present invention;

FIG. 5 illustrates a perspective view of a pre-assembled array of solar cells in a flat state, according to an embodiment of the present invention;

FIG. 6 illustrates a perspective view of a pre-assembled array of solar cells placed on a doubly curved surface, according to an embodiment of the present invention;

FIG. 7A illustrates a top view of a pre-assembled array of solar cells placed on a doubly curved surface according to detail 7A of FIG. 6, according to an embodiment of the present invention;

FIG. 7B illustrates a top view of a pre-assembled array of solar cells placed on a doubly curved surface according to detail 7B of FIG. 6, according to an embodiment of the present invention;

FIG. 8A illustrates a perspective view of a PFPC assembly tool positioned above a pre-assembled array of solar cells in a flat state, according to a method of the present invention;

FIG. 8B illustrates a perspective view of a PFPC assembly tool lowered onto and in contact with a pre-assembled array of solar cells in a flat state, according to a method of the present invention;

FIG. 8C illustrates a perspective view of a PFPC assembly tool with captive, pre-assembled array of solar cells, according to a method of the present invention;

FIG. 8D illustrates a perspective view of a PFPC assembly tool with captive, pre-assembled array of solar cells positioned above a doubly curved solar panel substrate, according to a method of the present invention;

FIG. 8E illustrates a perspective view of a PFPC assembly tool with captive, pre-assembled array of solar cells lowered onto and in partial contact with a doubly curved solar panel substrate, according to a method of the present invention;

FIG. 8F illustrates a perspective view of a PFPC assembly tool with captive, pre-assembled array of solar cells lowered onto and in full contact with a doubly curved solar panel substrate, according to a method of the present invention; and

FIG. 8G illustrates a perspective view of a PFPC assembly tool positioned above a pre-assembled array of solar cells placed and tacked onto a doubly curved surface solar panel substrate, according to an embodiment of the present invention.

### DETAILED DESCRIPTION

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. For a better understanding of the present invention, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

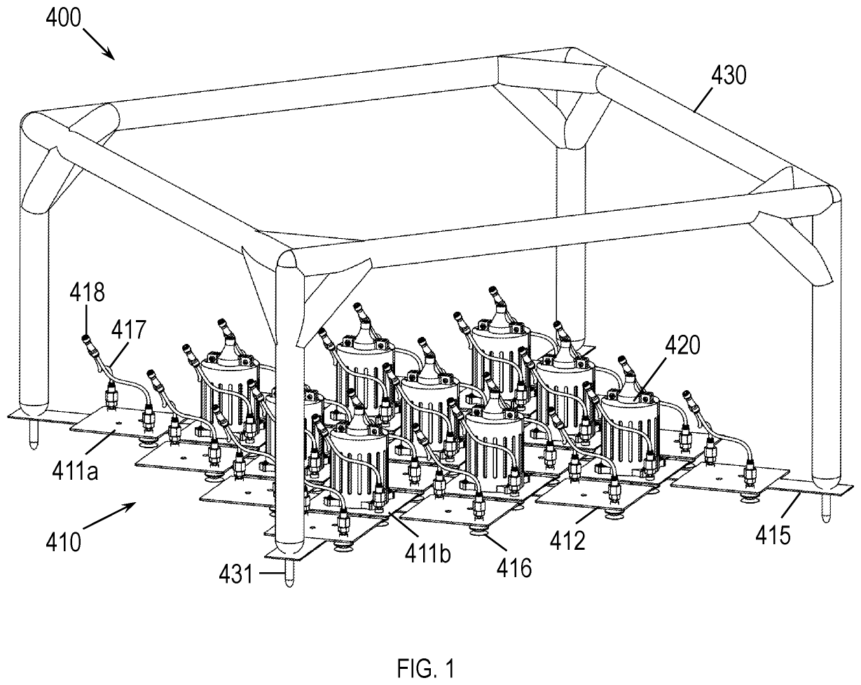

A pick-and-place assembly tool, system and method 400 is illustrated in FIGS. 1 through 8D. The pick-and-place assembly tool, system and method 400 comprises a flexible array of gripper heads, also referred to as suction head array 410, adapted to grab a sheet of flexible material or a pre-assembled array of flexibly coupled elements, such as solar cell array 200. In one embodiment, the pick-and-place assembly tool 400 may comprise a plurality of gripper heads 410 with sufficient suction force to lift a continuous sheet of flexible material 200. In another embodiment, the pick-and-place assembly tool 400 may comprise a plurality of gripper heads 410 including at least one gripper head for each element of an array of flexible elements 200. The flexible sheet 200 or pre-assembled array of elements 200 may be presented to the array of gripper heads 410 in a flat state. When lowered onto the pre-assembled array of elements 200, the array of gripper heads 410 is adapted to conform to the flat surface. After coupling to and grabbing the array of flexible elements 200, the assembly tool 400 moves to the compound curved, or doubly curved, placing surface 120, which may be a substrate. When lowered onto the placing surface 120, the pick-and-place assembly tool 400 may passively conform to the compound curved surface in a prescribed manner. In this way the flexible material or array of flexible elements may be transferred from a flat surface to a curved surface with a spatial transformation and precision alignment. In the following description of the embodiments, the specific example of a pre-assembled array of solar cells and doubly curved solar panel substrate are intended as exemplary in nature and should not be construed as limiting in any way.

FIG. 1 illustrates a first embodiment of a pick-flat, place-curved (PFPC) assembly tool 400. The assembly tool 400 comprises an array of gripper heads 410 arranged to grab an array of elements. At least one gripper head 411 may be provided for each element of the flexible array. Each gripper head 411a, 411b comprises a plate 412 flexibly connected to other plates in the array 410. The plate holds at least one suction cup 416 connected to a vacuum supply tube 417 terminated in an optional connector 418. Alternatively, the head may comprise one or more Bernoulli grippers connected to a pressure supply tube 417 with optional connector 418 for contactless handling of delicate solar cells. The connector 418 may be used to join multiple vacuum tubes 417 and suction cups 416. The gripper head array 410 may comprise a plurality of gripper head types. One type of gripper head 411a may provide suction only. Another type of gripper head 411b may provide suction and heat via an integral heater 420. The flexible gripper head array 410 comprises at least one heat-enabled gripper head 411b, which may be used to tack elements of the flexible array to the complex curved substrate prior to lamination. The array of gripper heads 410 may be flexibly connected to a frame 430 by tethers 415. The frame 430 comprises locating elements 431, such as pins, for mechanical alignment to the assembly surface and/or curved substrate. Alternatively, optical alignment may be used, such as for example, machine vision.

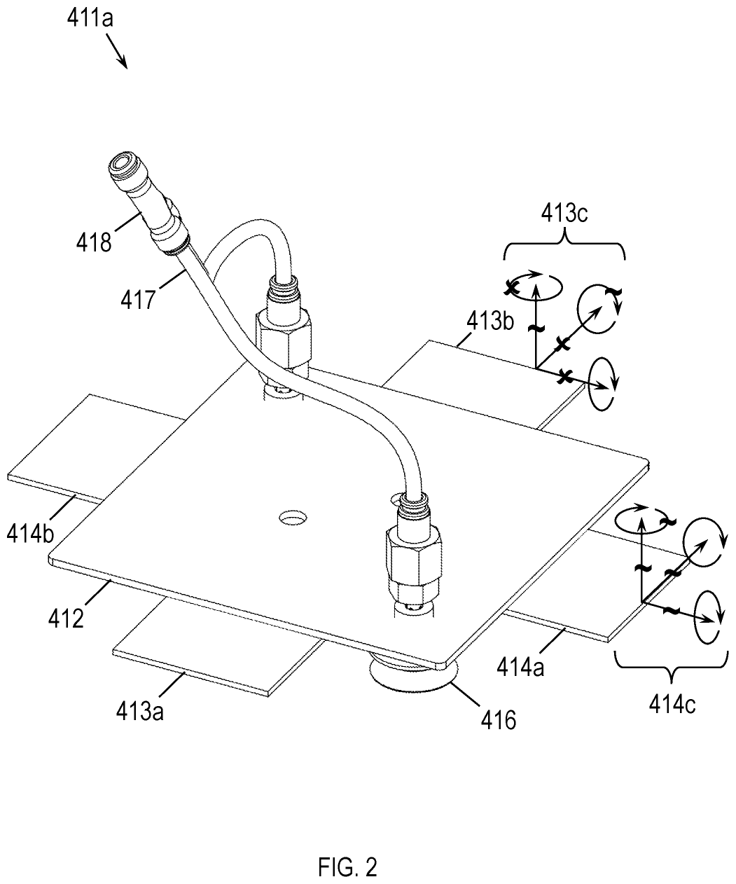

FIG. 2 shows the details of the suction-only head 411a which comprises a rigid plate 412 with at least one suction cup 416 disposed on the underside. The plate 412 may be made of glass, ceramic, metal, polymer, or other suitable material. Additional suction cups 416 may be used to spread the force of the vacuum over a larger area. Alternatively, a larger suction cup 116 could be used to do the same. Vacuum may be supplied to the cup(s) 116 by tubing 417 passing through the plate 412. An optional tubing termination 418, such as, for example, a quick release connector, may be disposed at an opposite end of the tubing 417. A connector 418 may be advantageously used to join a plurality of tubes 417 feeding a plurality of suction cups 416.

The plate 412 may be fitted with connector elements 413a, 413b, 414a, and 414b which flexibly join the gripper head 411a to its nearest neighbors in the gripper head array 410. The connector elements 413a, 413b, 414a, and 414b may be tailored to provide various spring-like functionalities, such as bending, elongation/compression, torsion, or shear. In this embodiment, the deformation of intra-row connector elements 413a-b is primarily restricted to bending, as shown by the degrees of freedom indicators 413c. The degrees of freedom are marked χ where disallowed or very limited, ˜ where controlled or somewhat limited, and are unmarked where minimally limited. The inter-row connector elements 414a and 414b, on the other hand, may be chosen to allow expansion/contraction, bending and torsion 414c between the rows of solar cells, which are mechanically uncoupled, so as to allow the distortion necessary to conform to the complex curved surface of the substrate. Other arrangements of springs or spring-like elements with different degrees of freedom are possible and the present embodiment shall not be construed as limiting. The connector elements 413a, 413b, 414a and 414b may be of various types and materials, such as, for example, metal springs, articulated joints, or elastomer sheets, among others. Metal springs may be of various types, including standard constant-force springs, rectangular springs, torsion springs, and the like. In the present embodiment, elastomer sheets couple nearest neighbor heads in the gripper head array 410 and are joined to the gripper head plate 412 with adhesive. Alternatively, the sheets may be coupled to the plate 412 with clamps, fasteners or other suitable means. In the present embodiment, control of element spacing is achieved though the incorporation of variable durometer elastomer sheets disposed between the plates 412.

For example, higher durometer sheets may be disposed between heads along a row, which require a fixed spacing, and lower durometer sheets may be disposed between heads of adjacent rows, which may have a variable spacing.

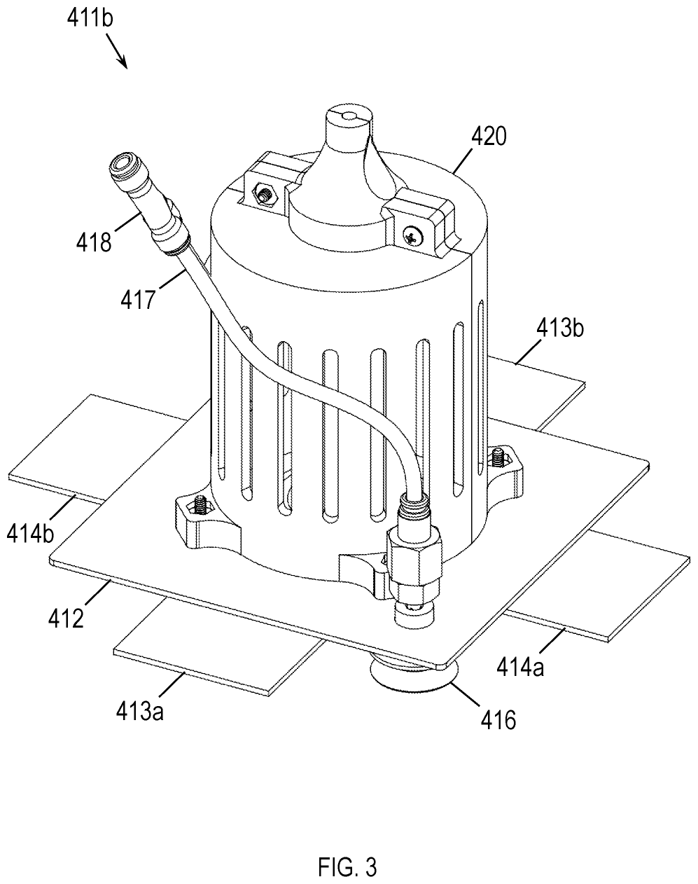

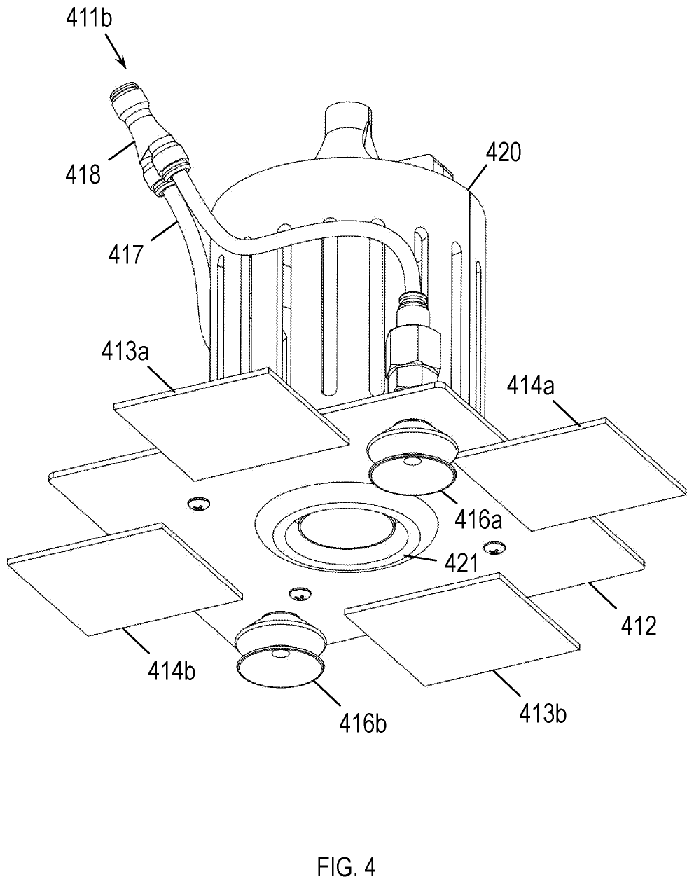

FIGS. 3 and 4 illustrate a heat-enabled gripper head 114b. This type of head comprises all of the elements of the suction-only head of FIG. 2 with the addition of a heating element 420. The heating element 420 is depicted in FIG. 3 as a forced air heater. Alternatively, the heating element may be of the resistive, microwave, infrared or other suitable type. The heating element may be used to tack a captive solar cell to the curved substrate by application of localized heat. To assist in directing the flow of heat to an appropriately sized area and location, a baffle 421 is disposed on the underside of the plate 412, as shown in FIG. 4. The baffle 421 may be made of any suitable material, such as rubber, foam rubber or other polymer with sufficient heat resistance. The baffle 421 may contact the captive solar cell or be proximal to it in order to contain the heat. In this way the baffle 421 serves to define the heat zone while at the same time protecting other elements of the gripper assembly 411b from the degrading effects of heat.

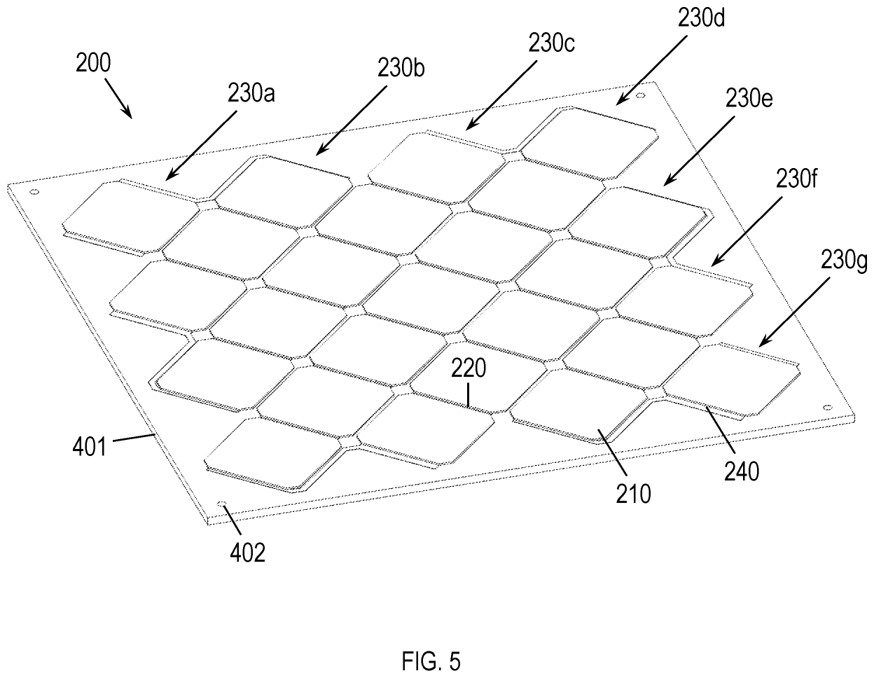

In FIG. 5 the pre-assembly of the 2D solar cell array is outlined. In a first step (not shown) the solar cells or strings of cells 230a-230g are arranged in an array 200 on a flat surface 401, solar-side down, such that the solder pads are facing up. The array 200 is aligned to registration marks or other fiducials 402 on the pre-assembly surface 401. If individual cells are placed, they may be soldered into strings (rows) 230a-230g with intra-row interconnects 220. In a second step (not shown) inter-row interconnects 240 are soldered to the row ends to connect the rows in series or in parallel according to the intended design. In FIG. 5 the rows 230a-230g are connected in series in a serpentine pattern. In a final step, the array is flipped upside down and is positioned solar side up with the interconnects on the bottom, as exhibited in FIG. 5. If a single type of both intra-row 220 and inter-row 240 interconnects are used, the gaps between the cells within a row and between rows 230a-230g are constant and equal. In the present embodiment, all gaps are equal in the flat, pre-assembled state shown in FIG. 5. However, the inter- and intra-row gaps may be varied in a flat state by using multiple sizes and/or types of interconnects. Therefore, the inter- and intra-row gaps may be varied in the flat state without departing from the spirit and scope of the present invention.

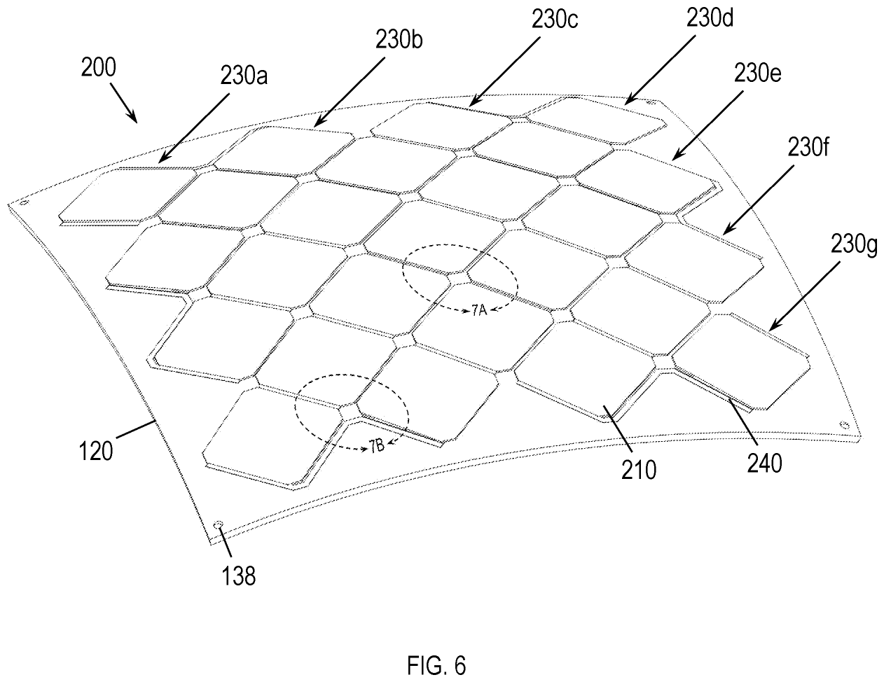

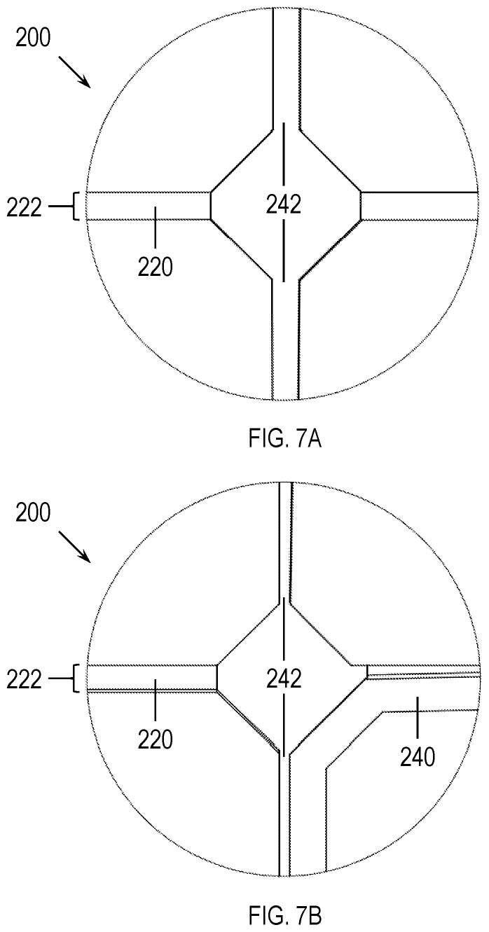

FIG. 6 illustrates the solar cell array 200 arranged on a complex curved substrate 120. In this state, some distortion of the uniform array of FIG. 5 is required. In the present embodiment, the intra-row spacing is constrained to remain constant relative to the pre-assembled state. Therefore, the gap between rows 230a-230g must vary to allow the cell array 200 to conform to the curved surface 120. Specifically, the gap widens near the center of the array and narrows near the ends of the rows. This effect may be more clearly seen in the detail views of 7A-7B. Referring to FIG. 7A located near the center of the array, the intra-row gap 222 is constrained by the intra-row interconnect 220. As such the gap 222 remains constant from the center of the row to the end of the row, shown in FIG. 7B. In contrast, the inter-row gap 242 is widest in the center and narrows considerably near the end of the row. The inter-row interconnect 240 may bend or twist to accommodate this shrinkage. This type of displacement may be mirrored in the gripper head array 410. Thus, the gripper head inter-row connectors 414a and 414b may allow for compression as well as extension. Alternatively, the connectors can be chosen such that only extension is allowed, that is, the minimum gap between rows 242 is equal to that of the flat array in the pre-assembled state of FIG. 5. In yet another alternative, the gripper head vacuum may be dynamically modulated to allow intra-row shrinkage, as, for example, by releasing the vacuum on every other row for cells 210 near the ends of the rows 230a-230g prior to tacking. A similar effect may be achieved by using Bernoulli grippers instead of suction cups, as the solar cells are allowed to translate slightly in response to a displacing and/or distorting force.

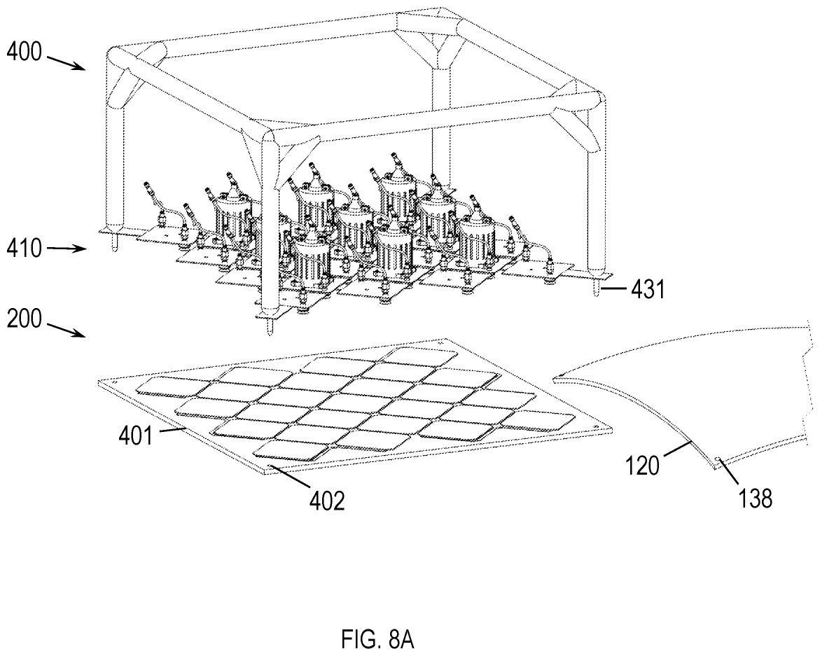

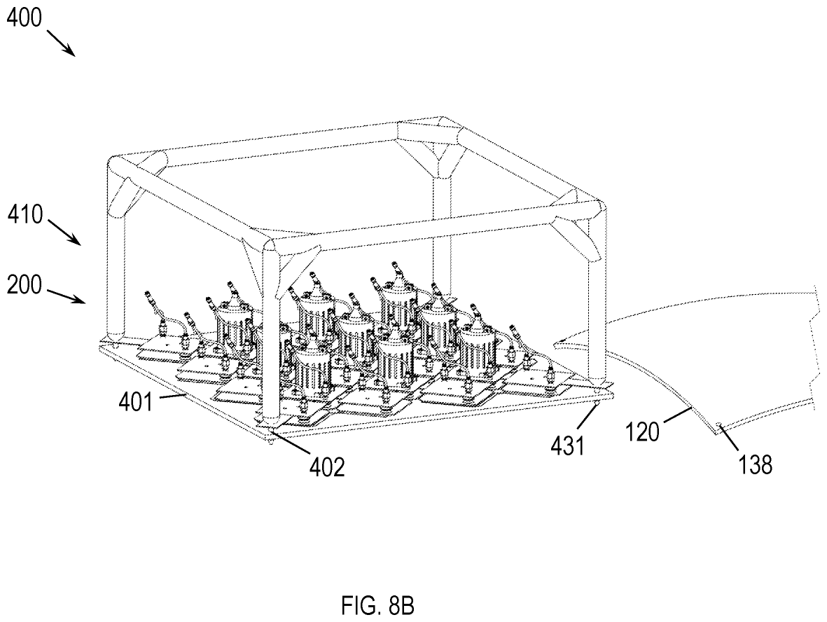

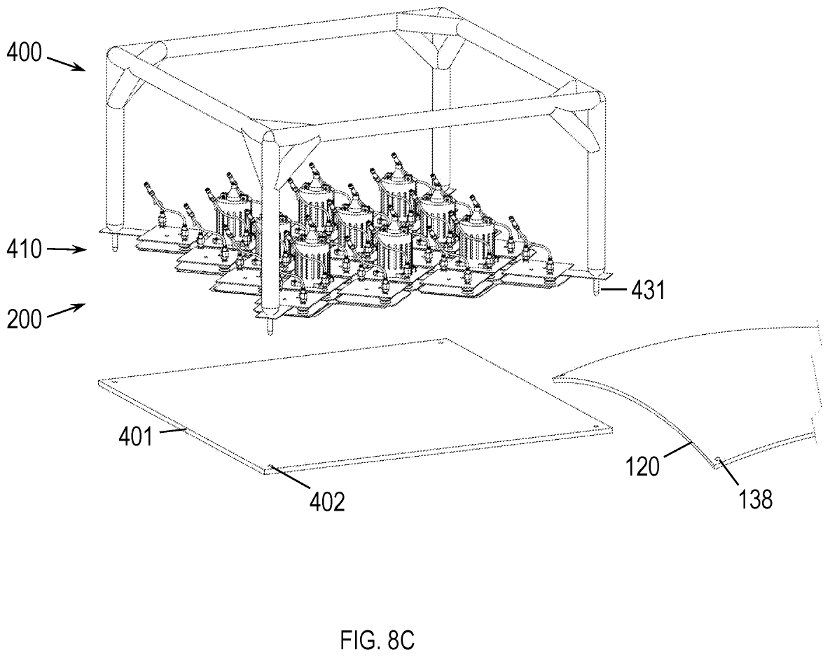

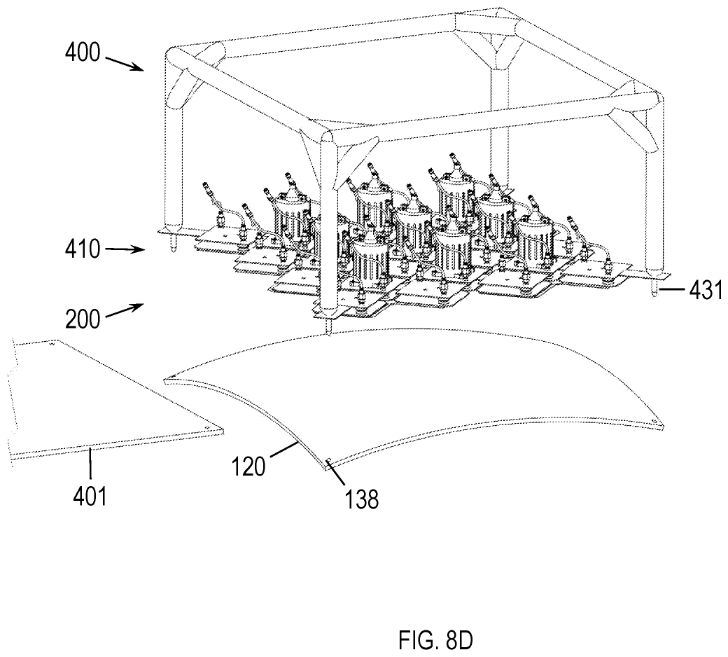

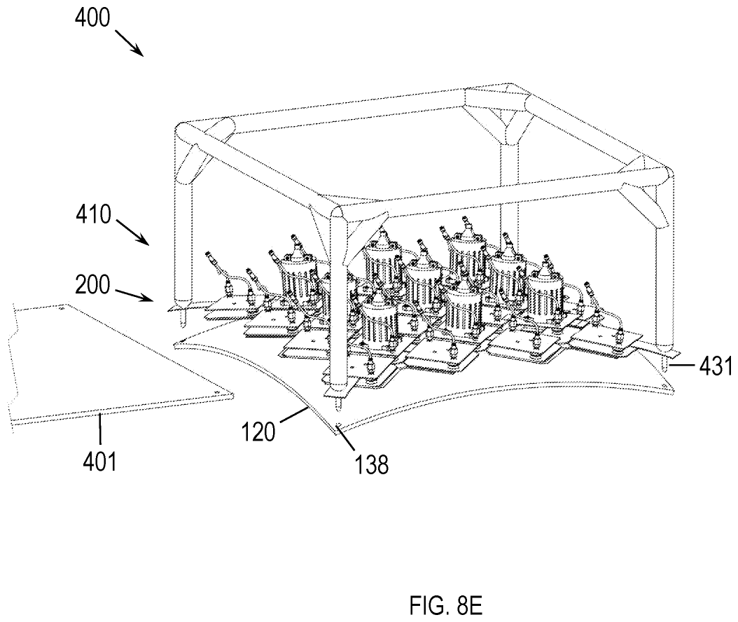

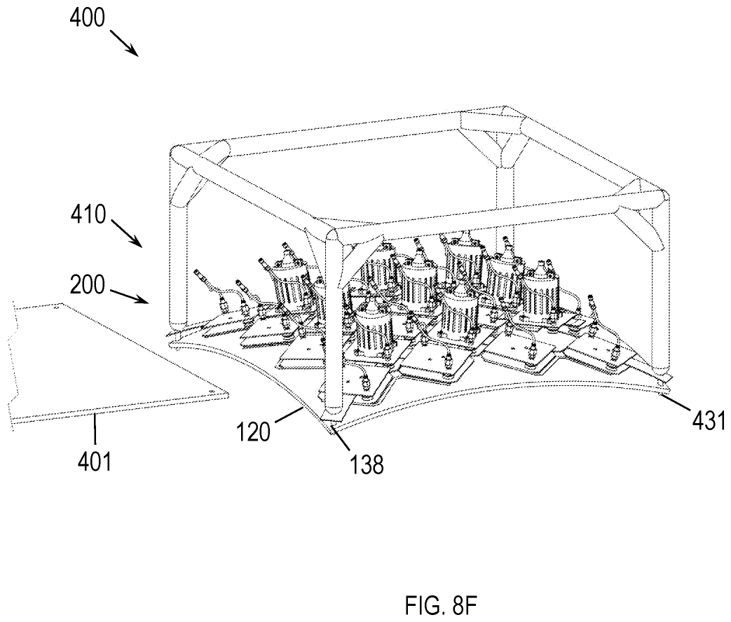

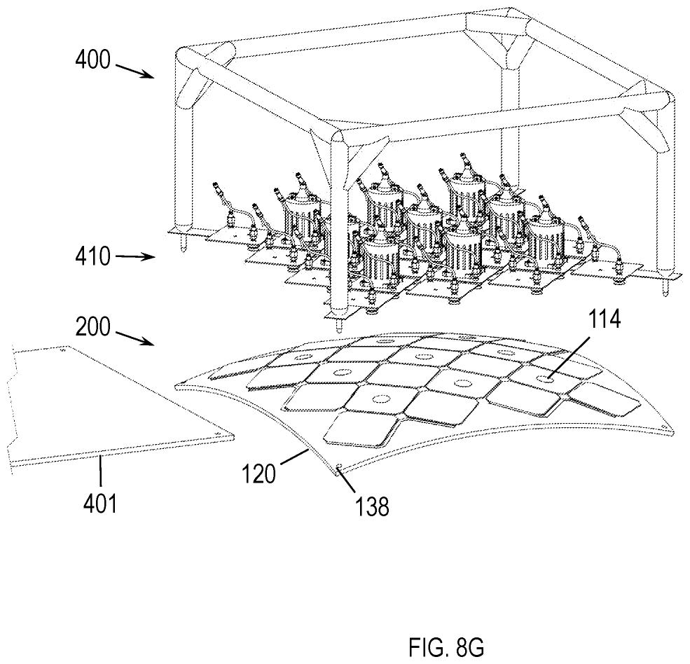

FIGS. 8A-8G illustrate the method of use of the PFPC assembly tool 400. In a first step, shown in FIG. 8A, the tool 400 is pre-aligned over the assembly surface 401 with the pre-assembled solar cell array 200 aligned with the assembly surface fiducials 402, which in this embodiment comprise holes for pins 431. In a second step, shown in FIG. 8B, the PFPC assembly tool 400 is lowered onto the assembly surface 401 and the frame pins 431 engage with the pin holes 402, thereby aligning the tool 400 to the assembly surface 401. The PFPC assembly tool 400 is further lowered until the suction cups 416 contact the solar cells 210 causing the gripper head array 410 to conform to the solar cell array 200. Vacuum is then supplied to the suction cups 416 which grab the solar cell array 200 in its aligned position. In FIG. 8C, the PFPC assembly tool 400 is raised along with the solar cell array 200 thereby completing the pick flat portion of the method. In FIG. 8D, the PFPC assembly tool 400 is moved over the curved substrate 120 and pre-aligned to the fiducials 138, which in this embodiment comprise holes for pins 431. In FIG. 8E the PFPC assembly tool 400 is lowered onto the curved surface 120, and the solar cell array 200 makes contact with the substrate 120 near the center causing the gripper head array 410 to begin to flex. In FIG. 8F the PFPC tool is further lowered until the alignment pins 431 engage with the pin holes 138 and the tool 400 is seated on the substrate 120. At this point, the gripper head array fully conforms to the complex curved surface of the substrate 120. With the vacuum still present, the heaters 420 are used to tack the solar cells 210 to the substrate 120. After tacking, the vacuum is released. If necessary, a small positive pressure is supplied to the suction cups 416 to aid in the release of the cells 200. Finally, in FIG. 8G, the PFPC tool 400 is raised, leaving the cell array 200 tacked 114 to the substrate 120 while the gripper head array 410 returns to its relaxed state. This completes the pick flat, placed curved operation.

The PFPC assembly tool may be dynamically or reconfigurably adapted to picking and placing of different quantities and arrangements of elements. This may be achieved in several ways. In a first embodiment, a vacuum regulating or on/off valve may be disposed in-line for each gripper head. The individually addressable valves may be programmatically configured to supply vacuum to a subset of the gripper heads in the array. This approach further allows for dynamic configurability for purposes such as the intra-row gap shrinkage previously mentioned. Alternatively, the vacuum lines may be joined into a manifold comprising a removable baffle that masks the flow of vacuum to the unused gripper heads, while allowing it to flow to gripper heads in service. To reconfigure the tool for a different component or product, a component-specific baffle is inserted into the manifold thereby selecting which gripper heads are vacuum enabled and which are not. This approach has the advantage of simplicity and reduced cost.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pick-and-place assembly tool comprising:
a support frame operably coupled to a plurality of gripper heads formed in an array, each gripper head comprising:
a plate having one or more suction elements; and
one or more connector elements,
wherein the gripper head is flexibly coupled to at least one adjacent gripper head by one or more connector elements, and
wherein the array of gripper heads is adapted to passively conform to a convex surface.

2. The assembly tool of claim 1 wherein the suction element is selected from the group consisting of: a hole, a suction cup, and a Bernoulli gripper.

3. The assembly tool of claim 1 wherein the one or more connector elements is selected from the group consisting of: a constant-force spring, a rectangular spring, a torsion spring, an articulated joint, and an elastomer sheet.

4. The assembly tool of claim 1 wherein each gripper head of the plurality of gripper heads comprises a heating element adapted to supply heat to the workpiece.

5. The heating element of claim 4 wherein the heating element is selected from the group consisting of: a resistive heater, a forced air heater, a ceramic heater, a semiconductor heater, a positive thermal coefficient heater, a thick film heater, and an infrared heater.

6. The assembly tool of claim 1 wherein the array comprises a plurality of rows.

7. The assembly tool of claim 6 wherein the one or more connector elements restricts the degrees of freedom between the gripper heads.

8. The assembly tool of claim 7 wherein the one or more connector elements restrict the elongation between the gripper heads within the rows and allow a variable displacement between the rows.

9. A system for picking flat and placing curved comprising:
the pick-and-place assembly tool of claim 1;
an apparatus adapted to lifting, translating and lowering the assembly tool; and
an apparatus adapted to aligning the assembly tool to an assembly table and a convex surface.

10. The system of claim 9 wherein apparatus adapted to lifting, translating and lowering the assembly tool is selected from the group consisting of: a robotic arm and a gantry.

11. The system of claim 9 wherein apparatus adapted to alignment is selected from the group consisting of: mechanical datums and machine vision.

12. A method of picking flat and placing curved, the method comprising:
aligning the assembly tool of claim 1 to an assembly table whereupon a flexible workpiece is disposed;
lowering the assembly tool onto the workpiece;
engaging the suction of the gripper heads;
lifting the assembly tool and captive workpiece;
translating the assembly tool to a position over the convex surface;
aligning the assembly tool to the convex surface;
lowering the assembly tool onto the convex surface;
disengaging the suction of the gripper heads; and
lifting the assembly tool to a position over the convex surface.

13. The method of claim 12 comprising the additional step of tacking the workpiece to the convex surface before disengaging the suction of the gripper heads.

14. The method of claim 12 wherein the assembly table and convex surface translate below a fixed assembly tool.
